(19) United States
(12) Patent Application Publication
(10) Pub. No.: US 2007/0033648 A1
(43) Pub. Date: Feb. 8, 2007

(54) Method for Executing Commands to Control a Portable Storage Device

(76) Inventors: Shih-Liang Wu, Tao-Yuan Hsien (TW); Shih-Chieh Liu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/277,228

(22) Filed: Mar. 22, 2006

(30) Foreign Application Priority Data
Aug. 3, 2005 (TW) 094126368

(51) Int. Cl. G06F 12/14

(52) U.S. Cl. 726/19

(57) ABSTRACT

A method for executing commands to a portable storage device is provided. A user can execute application programs of portable storage devices, such as login, disk partitioning, and password updating, on any computer. The method includes writing the command issued from the application program to a predetermined area of the portable storage device. Then the controller of the portable storage device will execute the command.

### BACKGROUND OF THE INVENTION

1. Field of the Invention

The present invention relates to a method for executing commands, and more particularly, to a method for executing commands without administrator rights.

2. Description of the Prior Art

Most portable storage devices available in the market today are storage media based on either micro hard disk technology or flash memory technology. Often when flash memory is being utilized as a storage media it is referred to as a flash disk or portable disk. The following example utilizes a portable disk to explain the limitations of the portable storage device.

In order to protect a user's data or other confidential files or programs stored in the portable disk such as the user's address book, notepad files, calendar events, personal creations such as word processing files, graphic files, passwords, keys of other systems, and log in files to other systems, it is apparent why the security function of the portable disk is being developed.

The modern security function of the portable disk is often configured with a block allocated as a security area for storing confidential files or programs. The user is required to pass a security check procedure before logging in to the security area. Usually this procedure involves a password and usually the password of the security area is stored within the disk itself.

FIG. 1 illustrates a conventional flowchart of a user logging in to a security area of a portable disk attached to a computer.

Step 100: a register program begins; a login program is being executed, the login program can be activated by a user or can be executed automatically;

Step 101: request the user to enter password;

Step 103: check whether the user's identity matches an administrator's identity; if so, proceed to step 105, if not, proceed to step 110;

Step 105: the login program executes a command to a disk controller to check the password;

Step 107: determine if the password is correct; a firmware of the controller executes the password check procedure by comparing the password previously entered by the user and a set of passwords stored within the portable disk; if the result is correct, proceed to step 108, if the result is not correct, return to step 101;

Step 108: login is completed; the user is allowed to login to the security area;

Step 110: end.

As shown in FIG. 1, in step 103, when the login program matches the user's identity to the administrator's identity, it represents that an activation program can execute a command to the firmware of the portable disk. Otherwise, if the user's identity is not matched to the administrator's identity, it represents that the login program cannot proceed further in the executing of a command to the firmware of the portable disk. This kind of scenario is common for computer systems that utilize a Microsoft operating system.

From the above-mentioned flow, the login of the security area of the portable disk is limited to a user of a host, as when the user's identity is the administrator's identity, the login program can only execute a command to the disk controller to perform actions of the login programs. Currently there are many actions requiring an administrator's identity. Some actions such as updating the portable disk security area password, disk partitioning, etc, can only be performed if the user's identity is the administrator's identity. Similarly, this scenario also exists when users access other media such as portable storage devices. However, not all of the computers that a user might wish to utilize are logged in utilizing the administrator's identity. In other words, the user or some other person may have successfully logged in to a particular computer, however, the particular account that was utilized for logging in to the computer does not posses an administrator's identity. For users that utilize portable storage devices on various hosts, the limitation of the above-mentioned scenario causes inconvenience for the users.

### SUMMARY OF THE INVENTION

To solve the problem of the above-mentioned, the claimed invention provides a method of executing commands to a portable storage device without administrator's privilege. According to the claimed invention, a non-administrator is still capable of executing application programs of the portable storage device such as login, disk partitioning, and updating passwords. The method of the claimed invention comprises writing the command issued from the application program to a predetermined area of the portable storage device. Then a controller of the portable storage device will execute a command corresponding to the data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional flowchart of a user logging in to a security area of a portable disk on a computer.

FIG. 2 illustrates a flowchart of logging in to a security area of a portable disk according to a first embodiment of the present invention.

FIG. 3 illustrates a login process according to a second embodiment of the present invention.

FIG. 4 illustrates a diagram of a conventional application program controlling an electronic apparatus connected to a computer.

FIG. 5 illustrates a diagram of an application program controlling an electronic apparatus connected to a computer according to the present invention.

FIG. 6 illustrates an operation of the application program of FIG. 5 according to the present invention.

FIG. 7 illustrates an operation of the controller of FIG. 5 according to the present invention.

### DETAILED DESCRIPTION

Firstly, to explain the characteristic of the present invention, the login to the security area of the portable disk is utilized as an example. The portable disk is first connected to a computer; the computer has an operating system such as Windows XP by Microsoft.

In step 201, a login process accessing the security area of the portable disk according to the present invention is initiated with a login program. The login program can be activated by a user or can be automatically activated after the portable disk is connected to the host.

In step 203, the user is requested to input a password. In general, a window appears to request the user to input the password required to login to the security area.

After obtaining the password inputted by the user, the login process proceeds to step 207, which a data including a verification command and the password, is stored into a predetermined area of a storage unit of the portable disk. The data storing operation in step 207 is similar to writing data to a file. The storage unit can be a flash memory, a hard disk, a micro hard disk, EEPROM, SRAM and the like.

Next, in step 210 the controller of the portable disk executes a corresponding action according to the contents of the predetermined area. At this time, the contents stored in the predetermined area include the verification command and the password inputted by the user in step 207, hence the controller executes a password verification. According to the present invention, the controller would monitor the data storing operation. If the controller detects that a data is being written or has been written to the predetermined area, the controller then operates according to the contents of the predetermined area.

In step 211, the password inputted by the user is being verified. If the password is correct, the user is allowed to login to the security area of the portable disk as in step 213, and then the login process ends in step 217. If the password is incorrect, the login process returns to step 203 to request the user to input a password again. In another embodiment, if the password is incorrect, hence step 217 is processed to end the login process.

In another embodiment, the controller will write a report data in the above-mentioned or other predetermined area to show the operating result of executing the command in the predetermined area. By reading the report data, the login program obtains the result of executing the command.

The login program of the present invention is different from the prior art. Specifically, in the prior art, only an administrator can perform the login process to access the security area of the portable disk. In addition, a command issued by the login program is directly sent to the portable disk controller, and the portable disk controller operates only after receiving the command issued from the login program. However, according to the present invention, the command from the login program is first stored in a predetermined area of a storage unit. When the portable disk controller detects that data is being written or has been written to the predetermined area, the portable disk then controller executes a corresponding action according to the contents in the predetermined area. As data storing operation is not limited to any administrator, thus the present invention can be realized. In other words, according to the present invention, both administrator and non-administrator can perform login process to access the security area of the portable disk.

As for other details, such as initial address of the predetermined area and the format of the command, it can be pre-defined by author of login program and manufacturer of the portable disk controller.

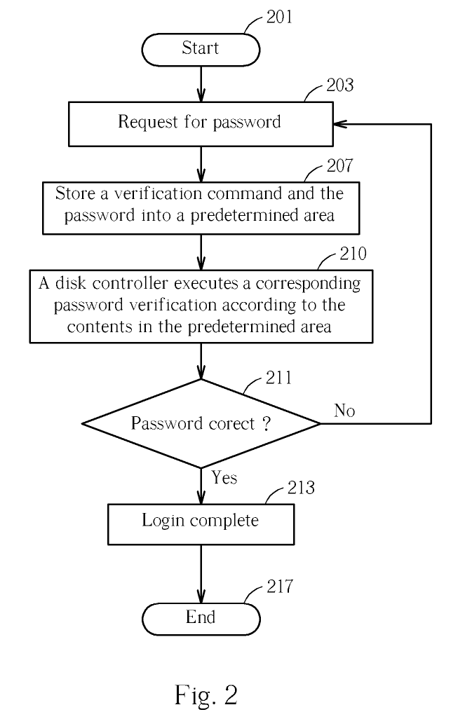

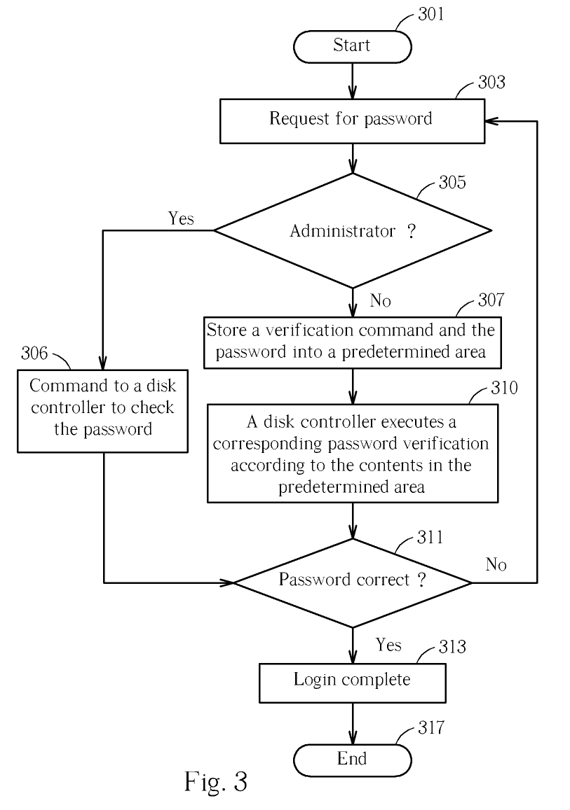

FIG. 3 illustrates a login process for both an administrator and a non-administrator according to another embodiment of the present invention. The differences between FIG. 3 and FIG. 2 are that step 305 and step 306 are further added, whereas the other steps are similar to FIG. 2.

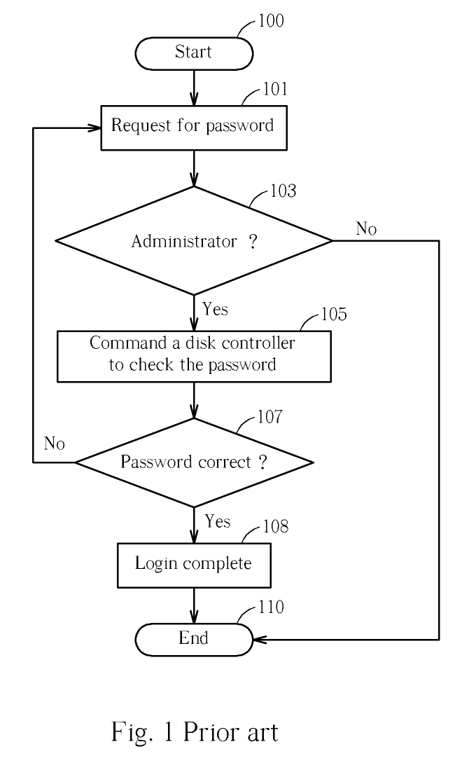

The branch that includes Step 305 and step 306 is similar to the prior art of FIG. 1. In step 305, the user's identification is still being checked if the user's identity matches the administrator's identity. If so, as is well known to those in the art, the login program can directly command the portable disk controller to verify the password inputted by the user, as in step 306.

If the computer user is not the administrator user, then proceed to step 307 and step 310. In step 307, the password verification command and the password inputted by the user are stored in a predetermined area of a storage unit of the portable disk. In step 310, the portable disk controller executes the corresponding password verification according to the contents of the predetermined area.

In a different embodiment of the present invention, the login process can be speed up by obtaining connection information between a host computer and its peripheral, so that the identity of user can be determined as soon as possible.

From the above-mentioned it is apparent that, according to the present invention, regardless of the user's identity, the action of logging in to the portable disk security area can be performed. Those skilled in the art can understand that the procedure of a login program storing a command into a predetermined area is performed by requiring the controller to write the command into the predetermined area. The present invention can also be applied to control other portable storage device and computer peripherals.

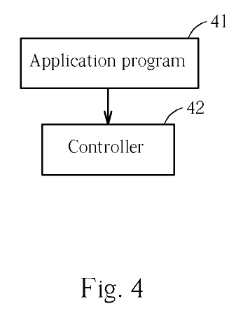

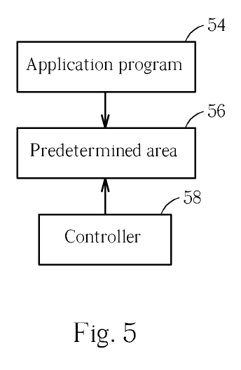

The present invention can be further understood through FIG. 4 and FIG. 5. An application program is executed on a computer. FIG. 4 illustrates a diagram of a conventional application program controlling an electronic apparatus connected to a computer. Application program 41 is able to directly command a controller 42 only for an administrator. The controller 42 begins to operate after receiving the command from the program 41. FIG. 5 illustrates a diagram of an application program controlling an electronic apparatus connected to a computer according to the present invention. A predetermined area 56 and a controller 58 are located within an electronic apparatus. A command from the application program 54 and related data are first stored in the predetermined area 56. If the controller 58 detects that a data is being stored or has been stored in the predetermined area 56, it then executes the following action according to the contents of the predetermined area 56. An obvious difference between the prior and the present invention can be seen by comparing FIG. 4 and FIG. 5. According to another embodiment of the present invention, the data in the predetermined area is deleted after the controller 58 executes the related action corresponding to the data, so that a next command issued by the application program 54 can be stored in that same location.

In other embodiments, the present invention can be applied to other host device, such as a mobile phone or a personal data assistant, to control its peripheral devices.

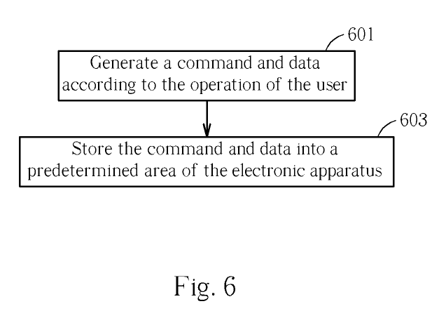

FIG. 6 illustrates an operation of the application program of FIG. 5. In step 601, the application program provides a command and related data according to the operation of the user. Next, in step 603, the command and data are stored into a predetermined storage area of the electronic apparatus.

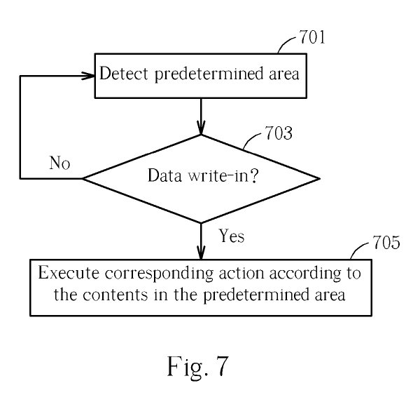

FIG. 7 illustrates operation of the controller of FIG. 5 according to an embodiment of the present invention. In step 701, the controller detects the predetermined area. In step 703, if data is detected in the predetermined area, then the flow proceeds to step 705. In step 705, the controller operates according to the data stored in the predetermined area. If data is not detected in the predetermined area, then the flow proceeds to step 701 to continue to detect the predetermined area. In other embodiment, since the controller knows where each data is going to be written to, and if the controller finds a data that is to be written into the predetermined area, the flow proceeds to step 705.

The present invention can be further applied to other situations. For example, by replacing the application program 54 with a controller, the controller will be able to command another controller by writing a command into the predetermined area. Besides, it is possible that the two controllers and the predetermined area are in the same electronic apparatus.

In other words, the present invention can be interpreted as a new method of controlling a controller to execute actions, which is different from the conventional method whereby commands are sent directly to the controller. The present invention first stores command and related information into a predetermined area, and the controller will detect if a data is being or has been stored into the predetermined area and then execute a corresponding action according to the contents stored in the predetermined area. Commands can be provided by an application program or another controller.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of logging in to a security area of a portable storage device, wherein the portable storage device comprises a controller and a storage unit, the portable storage device is provided to connect to a host, the method comprises following steps:
requesting a user to input password;
storing the password inputted by the user and a comparison command to a predetermined area of the storage unit;
executing action according to the contents stored in the predetermined area by the controller to determine whether the password is correct; and
granting the user logging in to the security area if the password is correct.

2. The method of claim 1 wherein the security area is located on the storage unit.

3. The method of claim 1 wherein the storage unit is selected from a group consisting of a flash memory, an EERPOM, a hard disk, and an SRAM.

4. The method of claim 2 wherein the storage unit is selected from a group consisting of a flash memory and a hard disk.

5. The method of claim 1 wherein if the password is incorrect, then the step of requesting the user to input a password is repeated.

6. The method of claim 1 wherein if the password is incorrect, the login flow is terminated.

7. The method of claim 1 further comprising following steps:
checking whether the host user is an administrator; and
if the user is the administrator, commanding the controller to verify the password.

8. The method of claim 1 further comprising writing the command execution result to the predetermined area or other predetermined area.

9. A method of controlling a controller wherein the controller and a storage unit are located within an electronic apparatus, the method comprises following steps:
providing commands and related data according to operation of a user; and
storing commands and related data to a predetermined area of the storage unit, wherein the controller executes corresponding actions according to the contents in the predetermined area.

10. The method of claim 9 wherein the electronic apparatus is a portable storage device.

11. The method of claim 9 wherein the storage unit is selected from a group consisting of a flash memory, an EERPOM, a hard disk, and an SDRAM.

12. An operating method of a controller, the method comprising following steps:
Writing a command to a predetermined area; and
executing a corresponding action according to the command.

13. The method of claim 12 further comprising deleting the command in the predetermined area after the corresponding action is executed.

14. The method of claim 12 further comprising writing the execution result to the predetermined area after the corresponding action is executed.

15. The method of claim 12 wherein the storage unit is selected from a group consisting of a flash memory, an EERPOM, a hard disk, and an SRAM.

16. An electronic apparatus comprising:
a connection port for receiving command from a host,
a storage unit comprising a predetermined area for storing the command; and
a controller for writing the command into the predetermined area and operating according to the command.

17. The electronic apparatus of claim 16 wherein the connection port is selected from a group consisting of a USB connection port and an IEEE1394 connection port.

18. The electronic apparatus of claim 16 wherein the storage unit is selected from a group consisting of a flash memory, an EERPOM, a hard disk, and an SRAM.

19. A method for an application program commanding a controller, the method comprising following steps:
providing commands and related data by the application program according to operation of a user;
writing the command and related data to a predetermined area by the controller; and
executing corresponding action according to the command and the related data in the predetermined area by the controller.

20. The method of claim 19 wherein the predetermined area is located on the storage unit and the storage unit is selected from a group consisting of a flash memory, an EERPOM, a hard disk, and an SDRAM.

21. The method of claim 19 further comprising deleting the command in the predetermined area after the controller executes the corresponding action.

22. The method of claim 19 further comprising writing the execution result to the predetermined area or other predetermined area after the controller executes the corresponding action.
